(19) United States
(12) Patent Application Publication
(10) Pub. No.: US 2007/0067506 A1
(43) Pub. Date: Mar. 22, 2007

(54) Multimedia program download control system and method of apparatus equipped with multimedia processor

(75) Inventor: Kyu Hyun Cho, Goyang-si (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: C&S TECHNOLOGY CO., LTD., Seoul (KR)

(21) Appl. No.: 11/348,087

(22) Filed: Feb. 6, 2006

(30) Foreign Application Priority Data
Aug. 9, 2005 (KR) 10-2005-0072893

(51) Int. Cl. G06F 13/28

(52) U.S. Cl. 710/22

(57) ABSTRACT

Disclosed is a multimedia program download system and method of an apparatus equipped with a multimedia processor, which is capable of downloading a mass of multimedia program through a host interface without using a boot ROM. The present invention provides a multimedia program download control system and method including a multimedia processor efficiently used for system configuration of mobile devices or PDAs, which is capable of downloading a multimedia program to drive a system faster than conventional multimedia program download control systems and methods and constructing a board system simply. The multimedia program download control system of an apparatus is equipped with a multimedia processor in which a multimedia program is downloaded from a host processor and is stored in a program area of a SDRAM. The multimedia processor comprises a host interface, a GDMA (General Purpose Direct Memory Access), a CPU and a reset controller. The host interface receives a download start signal and a download end command of the multimedia program from the host processor, receives the multimedia program by the unit of a predetermined size, transmits the received multimedia program to the GDMA.

### BACKGROUND OF THE INVENTION

1. Field of the Invention

The present invention relates to a multimedia program download system and method of an apparatus equipped with a multimedia processor, and more particularly, to a multimedia program download system and method of an apparatus equipped with a multimedia processor, which is capable of downloading a mass of multimedia program through a host interface without using a boot ROM.

2. Description of the Related Art

With the development of wireless Internet and various kinds of mobile communication devices such as mobile phones, PDAs (Personal Digital Assistants) and so on, people have progressively preferred smaller, highly speedy and low-priced mobile communication devices. To meet such preference, multimedia programs used for the mobile communication devices become gradually massive while semiconductors used in the mobile communication devices become gradually small.

The multimedia programs are downloaded by a board system composed of a host processor functioning as a master and a multimedia processor functioning as a slave. There exist various methods for a booting sequence system for controlling the download of the multimedia programs.

FIG. 1 is a view illustrating a multimedia program download control system using a conventional flash ROM, where a multimedia processor 20 has a separate flash ROM 40 to control program download internally, although a host processor 10 has a flash ROM 30.

The multimedia processor 20 includes a memory controller 21, a GDMA (General Purpose Direct Memory Access) 22, and a CPU 23, which are interconnected via a bus. The memory controller 21 controls the GDMA 22 to download a multimedia program stored in the flash ROM 40 into a SDRAM 50.

However, the multimedia program download control system as configured above has a disadvantage in that a cross section at a chip board level increases and costs for parts are relatively high due to the separate flash ROM 40, and therefore, is unsuitable for mobile devices whose chip board level has to be miniaturized.

In addition, although this multimedia program download control system is suitable for stand-alone typed terminals, it is unsuitable for a PDA, MSM (Mobile Station Modem) (baseband), Xscale and so on using the program download system by the host processor.

FIG. 2 is a view illustrating a multimedia program download control system using a conventional serial peripheral interface (SPI) system. The multimedia program download control system shown in FIG. 2 is different from that shown in FIG. 1 in that a multimedia processor 70 of the former controls program download using the SPI system without the flash ROM.

The multimedia processor 70 includes a memory controller 71, a boot ROM 72, a SPI controller 73 and an ARM (Advanced RISC Machine) 74, which are interconnected via a bus. A CPU (not shown) of the multiprocessor 70 executes the boot ROM 72 based on a control instruction from a host processor 60, thus activating the SPI controller 73. The activated SPI controller 73 controls to download a multimedia program stored in a flash ROM 80 of the host processor 60 into a SDRAM 90.

Such a multimedia program download control system using the SPI system has an advantage in that the multimedia processor requires no separate flash ROM. However, since the SPI system has a restriction of transmitting data one by one bit, there is a disadvantage in that it takes a long time to execute software having a big size, such as an embedded LINUX, for example.

### SUMMARY OF THE INVENTION

To overcome the above problem, it is an aspect of the present invention to provide a multimedia program download control system and method including a multimedia processor efficiently used for system configuration of mobile devices or PDAs, which is capable of downloading a multimedia program to drive a system faster than conventional multimedia program download control systems and methods and constructing a board system simply.

In order to accomplish the above objects, the present invention provides a multimedia program download control system of an apparatus equipped with a multimedia processor in which a multimedia program is downloaded from a host processor and is stored in a program area of a SDRAM, the multimedia processor comprising a host interface, a GDMA (General Purpose Direct Memory Access), a CPU and a reset controller, wherein the host interface receives a download start signal and a download end command of the multimedia program from the host processor, receives the multimedia program by the unit of a predetermined size, transmits the received multimedia program to the GDMA, and requests the CPU to release the reset controller when receipt of the multimedia program is completed, wherein the GDMA transmits the multimedia program of the unit of the predetermined size, which is received from the host interface, to the program area of the SDRAM and informs the host interface of the transmission of the multimedia program of the unit of the predetermined size, wherein the CPU releases the reset controller at the request from the host interface, and wherein the reset controller is released by the CPU.

In addition, the host interface comprises a Rx FIFO part of a Rx FIFO size.

In addition, the multimedia program is stored in the SDRAM through the GDMA when the host interface activates a full state of the Rx FIFO part, and the GDMA generates a data read completion signal (DMADONE) indicating that all the data have been read by an Rx FIFO size and transmits the generated data read completion signal (DMADONE) to the host interface.

In addition, upon receiving the end command from the host processor and the data read completion signal (DMADONE) from the GDMA, the host interface recognizes the completion of receipt of multimedia program.

In addition, the Rx FIFO part activates an R_FF signal when the multimedia program of the Rx FIFO size is stored, and, upon receiving the R_FF signal from the Rx FIFO, the host interface informs the GDMA of the full state of the Rx FIFO part.

Aslo, in order to accomplish the above object, the present invention provides a multimedia program download control method of an apparatus equipped with a multimedia processor in which a multimedia program is downloaded from a host processor and is stored in a program area of a SDRAM, the multimedia processor comprising a host interface, a GDMA, a CPU and a reset controller, comprising the steps of a first step of, by the host interface, receiving a download start signal from the host processor, a second step of, by the host interface, receiving the multimedia program by the unit of a predetermined size from the host processor through an external I/O, a third step of, by the host interface, transmitting the multimedia program of the unit of the predetermined size, which is received from the host processor, to the GDMA, a fourth step of, by the GDMA, transmitting the multimedia program of the unit of the predetermined size, which is received from the host interface, to the program area of the SDRAM, a fifth step of, by the GDMA, informing the host interface of the transmission of the multimedia program of the unit of the predetermined size, a sixth step of, by the host interface, receiving an end command informing the completion of transmission of all multimedia programs from the host processor, and a seventh step of, by the host interface, requesting the CPU to release the reset controller for execution of the multimedia programs.

In addition, the GDMA generates a data read completion signal (DMADONE) indicating that all the data have been read by an Rx FIFO size and transmits the generated data read completion signal (DMADONE) to the host interface.

In addition, upon receiving the end command from the host processor and the data read completion signal (DMADONE) from the GDMA, the host interface recognizes the completion of receipt of multimedia program.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a view illustrating a multimedia program download control system using a conventional flash ROM;

FIG. 2 is a view illustrating a multimedia program download control system using a conventional SPI system;

FIG. 3 is a view illustrating a multimedia program download control system of an apparatus equipped with a multimedia processor according to an embodiment of the present invention;

FIG. 4 is a flow chart illustrating a multimedia program download control method of the apparatus equipped with the multimedia processor according to the embodiment of the present invention;

FIG. 5 is a view illustrating a first method of operation between a host processor and a host interface according to the embodiment of the present invention;

FIG. 6 is a view illustrating a method of operation among the host processor, a GDMA and a SDRAM according to the embodiment of the present invention;

FIG. 7 is a view illustrating a second method of operation between the host processor and the host interface according to the embodiment of the present invention; and

FIG. 8 is a view illustrating a method of operation among the host processor, a reset controller, a CPU and the SDRAM according to the embodiment of the present invention.

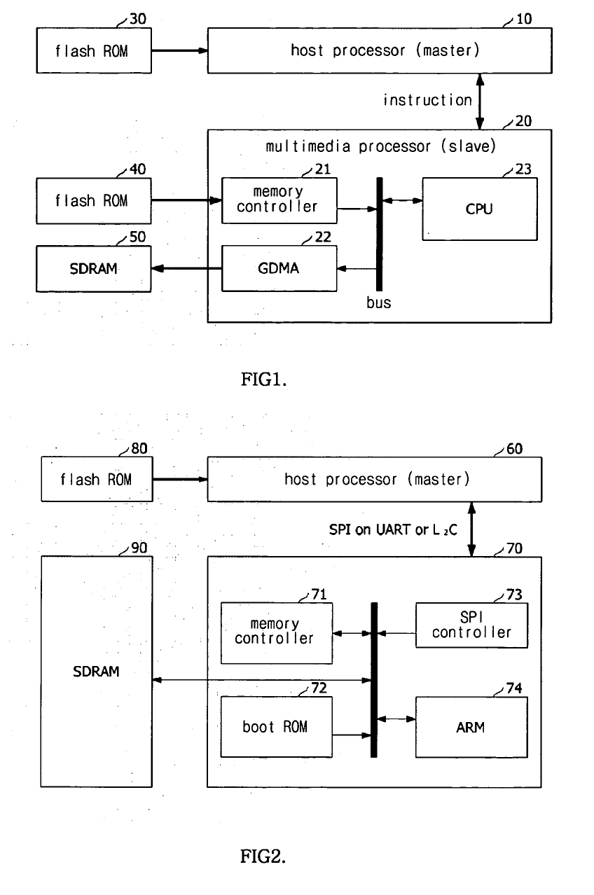

### DETAILED DESCRIPTION OF THE PREFERRED EMBODIMENT

Reference will now be made in detail to exemplary embodiments of the present invention, examples of which are illustrated in the accompanying drawings.

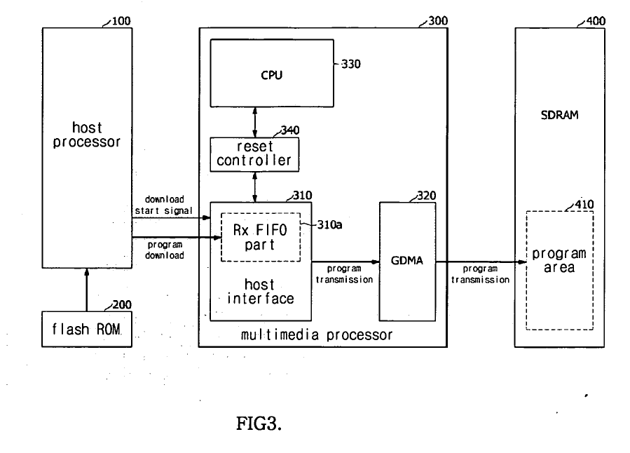

FIG. 3 is a view illustrating a multimedia program download control system of an apparatus equipped with a multimedia processor according to an embodiment of the present invention, where a multimedia processor 300 downloads a multimedia program from a flash ROM 200 of a host processor 100 and stores the downloaded multimedia program in a program area of a SDRAM 400.

Referring to FIG. 3, the multimedia processor 300 includes a host interface 310, a GDMA (General Purpose DMA) 320, a CPU 330 and a reset controller 340 and downloads the multimedia program through a booting bit indicating a booting mode and external I/O 8 bits or 16 bits of the host processor 100.

The host interface 310 receives a download start signal and a download end command of the multimedia program from the host processor 100 through a particular pin called ‘BOOTCFG’, receives the multimedia program using an internal Rx FIFO part 310a having a Rx FIFO size, and transmits the received multimedia program to the GDMA 320.

When the host interface 310 informs the GDMA 320 of a full state of the Rx FIFO part 310a, the GDMA 320 performs a program download operation. In addition, as a host booting is completed, the host interface 310 requests the CPU 330 to release the reset controller 340.

The GDMA 320 transmits in turn the multimedia program received from the host interface 310 to a program area 410 of the SDRAM 400 starting from address 0, which is a start address. In addition, when the multimedia program is transmitted by the Rx FIFO size every time, the GDMA 320 always transmits a data read completion signal DMADONE to the host interface 310 to inform the host interface 310 of the transmission of the multimedia program.

The CPU 330 releases the reset controller 340 at the request from the host interface 310.

The reset controller 340 is released by the CPU 330.

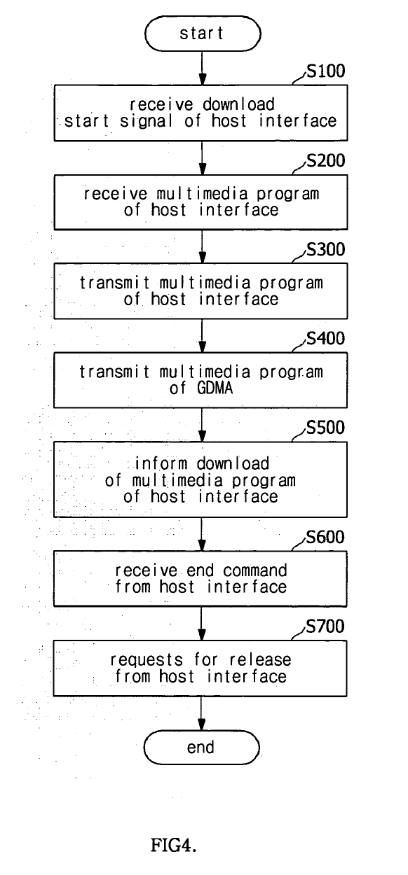

FIG. 4 is a flow chart illustrating a multimedia program download control method of the apparatus equipped with the multimedia processor according to the embodiment of the present invention.

Referring to FIG. 4, first, the host processor 100 as a master transmits the download start signal to the host interface 310 through the particular pin called BOOTCFG to transmit the multimedia program required to operate a system in the multimedia processor 300 as a slave (Step S100).

Next, when the host processor 100 is booted, the host processor 100 transmits the multimedia program to the host interface 310 through an external I/O (Step S200). Here, when the host processor 100 transmits the multimedia program, the host interface 310 receives the multimedia program by the unit of Rx FIFO size through the internal Rx FIFO part 310a.

Next, the multimedia program received in the Rx FIFO part 310 of the host interface 310 is transmitted to the GDMA 320 (Step S300). Here, the Rx FIFO part 310a of the host interface 310 activates an R_FF signal when the multimedia program of the Rx FIFO size is stored, and the host interface 310 receives the R_FF signal from the Rx FIFO part 310a and then informs the GDMA 320 of the full state of the Rx FIFO part 310a so that the GDMA 320 performs the program download operation.

Next, the GDMA 320 transmits in turn the multimedia program received from the Rx FIFO part 310a of the host interface 310 to the program area 410 of the SDRAM 400 starting from address 0, which is a start address (Step S400).

Next, when the multimedia program is transmitted by the Rx FIFO size every time, the GDMA 320 transmits the data read completion signal DMADONE to the host interface 310 to inform the host interface 310 of the transmission of the multimedia program (Step S500).

Next, after the program transmission is completed, the host processor 100 sends the host interface 310 an end command informing that all multimedia programs for driving the system are transmitted to the host interface (Step S600). Upon receiving the end command from the host processor 100 and the data read completion signal DMADONE from the GDMA 320, the host interface 310 recognizes that all the multimedia programs have been internally transmitted.

Finally, as the host booting is completed, the host interface 310 requests the CPU 330 to release the reset controller 340 (Step S700). When the CPU 330 releases the reset controller 340, the multimedia program received from the host processor 310 is executed.

FIG. 5 is a view illustrating a first method of operation between the host processor and the host interface according to the embodiment of the present invention, showing a method in which the host processor 100 downloads the multimedia program through the host interface 310.

In existing systems such as MSM and Xscale, when the ‘BOOTCFG’ pin of the host interface 310 is activated by the host processor 100, it can be predicted that a booting processor for downloading the multimedia program to drive the system starts to operate.

In other words, the host interface 310 enters a “booting process state machine” based on an activation instruction of the ‘BOOTCFG’ pin from the outside, and then, the multimedia processor 300 starts to receive the multimedia program from the flash ROM 200 of the host processor 100 through the host interface 310.

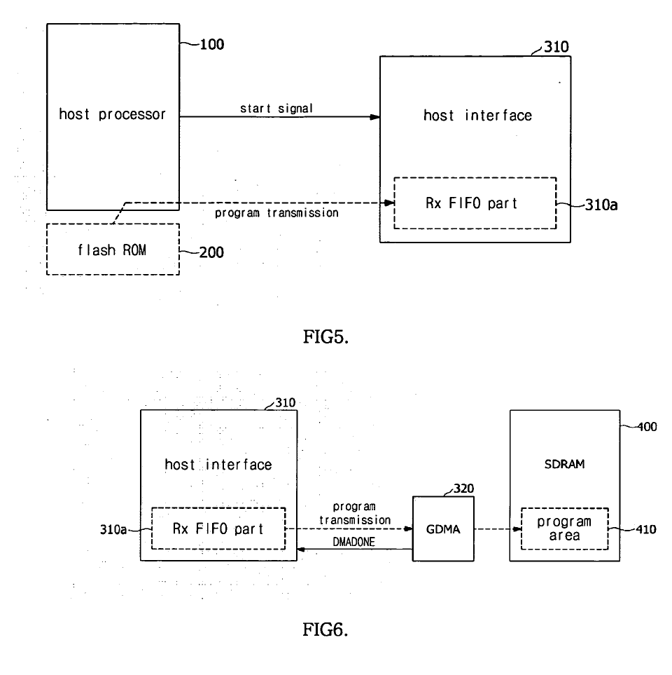

FIG. 6 is a view illustrating a method of operation among the host processor, the GDMA and the SDRAM according to the embodiment of the present invention, showing a method in which the multimedia program downloaded from the host processor 100 is transmitted to the SDRAM 400 through the host interface 310.

The host interface 310 stores the multimedia program received from the host processor 100 in the Rx FIFO part 310a of the host interface 310, and the Rx FIFO part 310a activates the R_FF signal when the multimedia program of the Rx FIFO size (for example, 512 words (512×32)) is stored.

Upon receiving the R_FF signal from the Rx FIFO part 310a, the host interface 310 informs the GDMA 320 of the full state of the Rx FIFO part 310a, and the GDMA 320 stores the multimedia program stored in the Rx FIFO part 310a in an external memory such as the SDRAM 400.

In this manner, the GDMA 320 downloads the multimedia program and stores in turn the downloaded multimedia program in the program area 410 of the SDRAM 400 starting from address 0.

When the GDMA 320 reads data by the Rx FIFO size, it transmits the fact that all data are read to the host interface 310.

A series of process for the multimedia program transmission is repeated until a particular multimedia program is wholly downloaded. More specifically, the multimedia program transmitted from the host processor 100 is stored by the Rx FIFO size in the Rx FIFO part 310a of the host interface 310, the multimedia program is stored in the SDRAM 400 when the host interface 310 activates the full state of the Rx FIFO part 310a, and the GDMA 320 generates the data read completion signal DMADONE indicating that all the data have been read by the size of the Rx FIFO part 310a and transmits the generated data read completion signal DMADONE to the host interface 310.

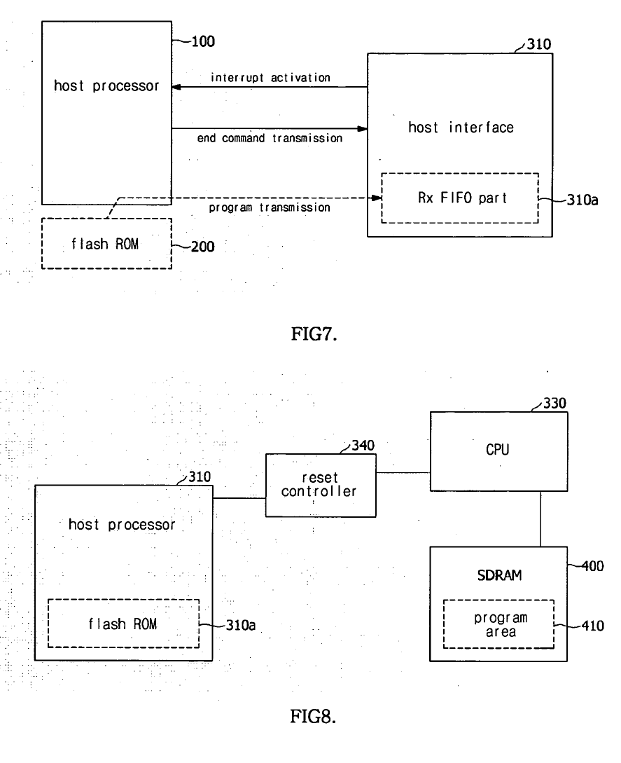

FIG. 7 is a view illustrating a second method of operation between the host processor and the host interface according to the embodiment of the present invention, showing a method by which the host interface 310 can know the time when the multimedia program stored in the Rx FIFO part 310a and transmitted to the program area 410 of the SDRAM 400 through the GDMA 320 is successively received in the host interface 310 and the multimedia program transmission is completed.

The host interface 310 controls the multimedia program stored in the flash ROM 200 of the host processor 100 to be successively transmitted to the program area 410 of the SDRAM by activating the R_FF signal whenever the Rx FIFO part 310a is in an empty state and activating an interrupt of the host processor 100.

This transmission process is ended when the host processor 100 sends the host interface 310 the end command informing that all multimedia programs have been transmitted. The host interface 310 continues to monitor the end command through an internal ‘booting process state machine’.

Since the host interface 310 sets the end command as a reserved command internally, a point of time when download of all multimedia programs for driving the system is completed can be known by the ‘booting process state machine’ when the host interface 310 receives the end command (for example, 0 xaa).

FIG. 8 is a view illustrating a method of operation among the host processor, a reset controller 340, a CPU 330 and the SDRAM according to the embodiment of the present invention, showing a method in which the CPU 330 executes the multimedia program to operate the system.

When the host interface 310 knows the completion of transmission of all multimedia programs and receives the data read completion signal DMADONE and a command 0xaa, the CPU 330 releases the reset controller 340 and then reads the multimedia program downloaded in the program area 410 of the SDRAM 400 starting from address 0 in order to drives the system.

As described above, the present invention does not employ the program download system through the internal flash ROM 200, but uses the flash ROM 200 of the external host processor 100. Accordingly, the multimedia processor 300 has no need to have a separate flash ROM. In addition, since the operation of transmission of the multimedia program is performed by a host interface without using the internal CPU 330, power consumption can be minimized, and mass programs such as linux can be downloaded at a high speed.

As apparent from the description, the present invention provides a multimedia program download control system and method including a multimedia processor efficiently used for system configuration of mobile devices or PDAs, which is capable of downloading a multimedia program to drive a system faster than conventional multimedia program download control systems and methods and constructing a board system simply.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A multimedia program download control system of an apparatus equipped with a multimedia processor in which a multimedia program is downloaded from a host processor and is stored in a program area of a SDRAM, the multimedia processor comprising a host interface, a GDMA (General Purpose Direct Memory Access), a CPU and a reset controller,
wherein the host interface receives a download start signal and a download end command of the multimedia program from the host processor, receives the multimedia program by the unit of a predetermined size, transmits the received multimedia program to the GDMA, and requests the CPU to release the reset controller when receipt of the multimedia program is completed,
wherein the GDMA transmits the multimedia program of the unit of the predetermined size, which is received from the host interface, to the program area of the SDRAM and informs the host interface of the transmission of the multimedia program of the unit of the predetermined size,
wherein the CPU releases the reset controller at the request from the host interface, and
wherein the reset controller is released by the CPU.

2. The multimedia program download control system according to claim 1, wherein the host interface comprises a Rx FIFO part of a Rx FIFO size.

3. The multimedia program download control system according to claim 2, wherein the multimedia program is stored in the SDRAM through the GDMA when the host interface activates a full state of the Rx FIFO part, and the GDMA generates a data read completion signal (DMADONE) indicating that all the data have been read by an Rx FIFO size and transmits the generated data read completion signal (DMADONE) to the host interface.

4. The multimedia program download control system according to claim 3, wherein, upon receiving the end command from the host processor and the data read completion signal (DMADONE) from the GDMA, the host interface recognizes the completion of receipt of multimedia program.

5. The multimedia program download control system according to claim 3, wherein the Rx FIFO part activates an R_FF signal when the multimedia program of the Rx FIFO size is stored, and, upon receiving the R_FF signal from the Rx FIFO, the host interface informs the GDMA of the full state of the Rx FIFO part.

6. A multimedia program download control method of an apparatus equipped with a multimedia processor in which a multimedia program is downloaded from a host processor and is stored in a program area of a SDRAM, the multimedia processor comprising a host interface, a GDMA, a CPU and a reset controller, comprising the steps of:
a first step of, by the host interface, receiving a download start signal from the host processor;
a second step of, by the host interface, receiving the multimedia program by the unit of a predetermined size from the host processor through an external I/O;
a third step of, by the host interface, transmitting the multimedia program of the unit of the predetermined size, which is received from the host processor, to the GDMA;
a fourth step of, by the GDMA, transmitting the multimedia program of the unit of the predetermined size, which is received from the host interface, to the program area of the SDRAM;
a fifth step of, by the GDMA, informing the host interface of the transmission of the multimedia program of the unit of the predetermined size;
a sixth step of, by the host interface, receiving an end command informing the completion of transmission of all multimedia programs from the host processor; and
a seventh step of, by the host interface, requesting the CPU to release the reset controller for execution of the multimedia programs.

7. The multimedia program download control method according to claim 6, wherein the GDMA generates a data read completion signal (DMADONE) indicating that all the data have been read by an Rx FIFO size and transmits the generated data read completion signal (DMADONE) to the host interface.

8. The multimedia program download control method according to claim 7, wherein, upon receiving the end command from the host processor and the data read completion signal (DMADONE) from the GDMA, the host interface recognizes the completion of receipt of multimedia program.
